(19) United States
(12) Patent Application Publication
(10) Pub. No.: US 2004/0084814 A1
(43) Pub. Date: May 6, 2004

(54) Powder removal system for three-dimensional object fabricator

(76) Inventors: Melissa D. Boyd, Corvallis, OR (US); Jeffrey Nielsen, Corvallis, OR (US)

Correspondence Address: HEWLETT-PACKARD COMPANY, Intellectual Property Administration, P. O. Box 272400, Fort Collins, CO, 80527-2400, US

(21) Appl. No.: 10/286,260

(22) Filed: Oct. 31, 2002

(51) Int. Cl. B29C 31/04; B28B 11/24

(52) U.S. Cl. 264/497; 425/174.4; 425/216; 425/375; 264/109

(57) ABSTRACT

A three-dimensional object fabricator with an unbound powder removal system is disclosed. The object fabricator forms an object by binding regions of unbound powder in a chamber having the unbound powder removal system operably secured thereto. Unbound powder is removed from the chamber by the unbound powder removal system.

### BACKGROUND OF THE INVENTION

Three-dimensional object fabricators form a physical object, such as a prototype structure, from a computer data model of that object. Accordingly, they allow engineers and designers to quickly and cheaply build a scale model of a particular structure for evaluation purposes and before committing that structure to production or the like.

In general, three-dimensional object fabricators form the object by selectively bonding regions of powder in a powder-filled chamber. For example, one commercially available three-dimensional object fabricator, which is manufactured and sold by the Z Corporation of Burlington, Mass. under the trademark Z406, builds the object in layers. The object fabricator deposits a layer of unbound powder into a chamber, then selectively deposits bonding material onto the layer of powder to produce a region of bound powder. The location of the bonding material corresponds with a particular section of the object to be built. A new layer of powder is then added on top of the existing layer of powder, and the bonding material is then selectively deposited onto portions of the new layer of powder. This process is repeated until the region of bound powder defines the object to be formed.

After fabrication of the object with a three-dimensional object fabricator, the object resides embedded in a chamber of unbound powder. Accordingly, to obtain the object from the chamber the operator must do one of two things:

1) in a manner similar to retrieving a prize from a full box of breakfast cereal, physically sift through the unbound powder, locate the object, and then lift if from the chamber. This process necessarily spills a great deal of unbound powder around the object fabricator. The powder is very fine and difficult to clean-up easily. Moreover, the process of locating and removing the object through the unbound powder frequently damages the object; or,

2) use a hand-held vacuum to remove the unbound material from the chamber, and then retrieve the object after all of the unbound material has been removed. However, in the process of moving the nozzle around the chamber to remove the unbound material, the operator can inadvertently contact the object and damage it.

Moreover, after the object is removed from the chamber, it is usually placed into an auxiliary, free-standing, vacuum chamber wherein any remaining unbound powder is removed from the object. This auxiliary vacuum chamber is costly and usually occupies valuable floor space. Moreover, physically removing the object from the object fabricator and placing it into an auxiliary vacuum chamber usually produces an undesirable trail of unbound powder running from the object fabricator to the auxiliary vacuum.

For these and other reasons, there is a need for the present invention.

### SUMMARY OF THE INVENTION

The present invention may be embodied in a three-dimensional object fabricator that forms an object in a chamber of unbound powder with a powder removal system operably secured to the chamber such that unbound powder may be removed from the chamber.

### BRIEF DESCRIPTION OF THE DRAWINGS

FIG. 1 is a schematic, isometric diagram of a three-dimensional object fabricator having an integral unbound powder removal system therein in accordance with an embodiment of the present invention.

FIGS. 2A-2D are schematic diagrams of an exemplar process in accordance with an embodiment of the present invention for using the three-dimensional object fabricator of FIG. 1 to fabricate an object by selectively binding regions of powder in a chamber and then activating the integral unbound powder removal system to remove remaining unbound powder from the chamber.

FIG. 3 is an exemplar, enlarged, schematic view of a powder chamber of a three-dimensional object fabricator according to an embodiment of the present invention showing a possible configuration of an integral powder removal system in an inactive position.

FIG. 4 is the exemplar, enlarged, schematic view of the powder chamber of FIG. 3, wherein the integral powder removal system is in an active position.

FIG. 5 is a schematic diagram of an alternative orientation of the air vents and vacuum vents in the powder chamber of an exemplar three-dimensional object fabricator according to an embodiment of the present invention.

FIG. 6A is a schematic diagram of a three-dimensional object fabricator having an integral unbound powder removal system therein in accordance with an alternative embodiment of the present invention, showing first possible air and vacuum paths to and from the powder chamber.

FIG. 6B is a schematic diagram of the three-dimensional object fabricator of FIG. 6A, showing second possible air and vacuum paths to and from the powder chamber.

### DETAILED DESCRIPTION

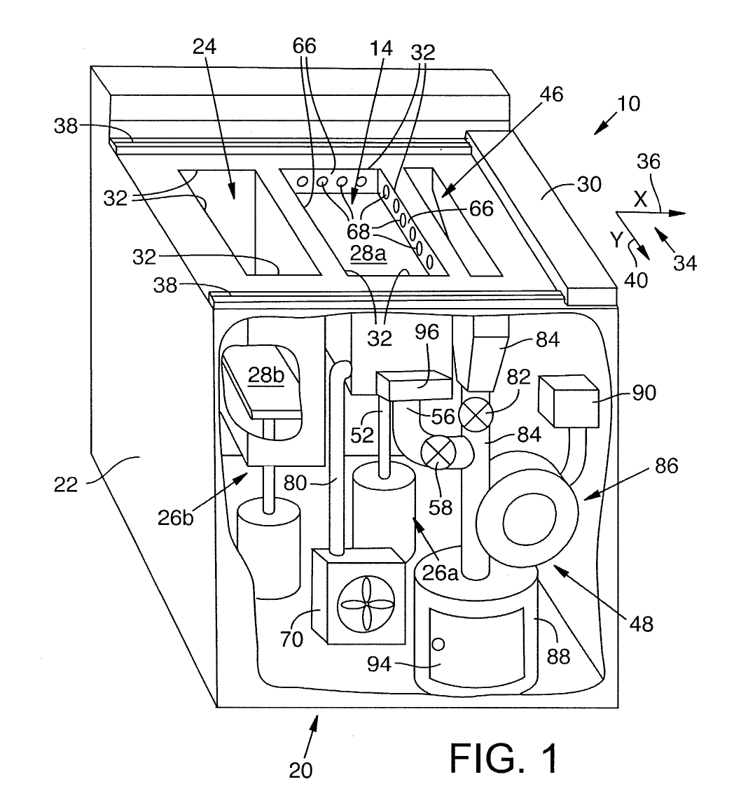

A three-dimensional object fabricator 10 that fabricates an object 12 in a building chamber 14 of unbound powder 16 with an integral unbound powder removal system 20 operably secured to the building chamber 14 is shown in FIGS. 1-6B.

A. Exemplar Three-Dimensional Object fabricator

An exemplar three-dimensional object fabricator 10 is shown in FIG. 1. In general, the three-dimensional object fabricator 10 includes a frame 22 housing an unbound powder source chamber 24 and the building chamber 14 therein. Each chamber 14, 24 includes a movable piston assembly 26a, 26b, respectively, that is in communication with and commanded by a computer system (not shown). Each piston assembly 26a, 26b can raise or lower the floor 28a, 28b, respectively of their respective chambers 14, 24.

A movable carriage 30 is operably secured to the frame 22 adjacent to the upper edges 32 of the chambers 14, 24 and thereby defining an x-y plane 34. The carriage 30 includes a printhead, which may be either an inkjet or laser-type printhead or the like, in fluid communication with a bonding fluid source (not shown) such that it can eject bonding fluid (not shown) as commanded by the computer system. The carriage 30 is movable in an x-direction 36 along rails 38 positioned on the frame 22. In addition, the printhead is movable in a y-direction 40 along the carriage 30. Accordingly, the printhead can be positioned and repositioned by the computer system at any defined coordinates on the x-y plane 34 over the building chamber 14.

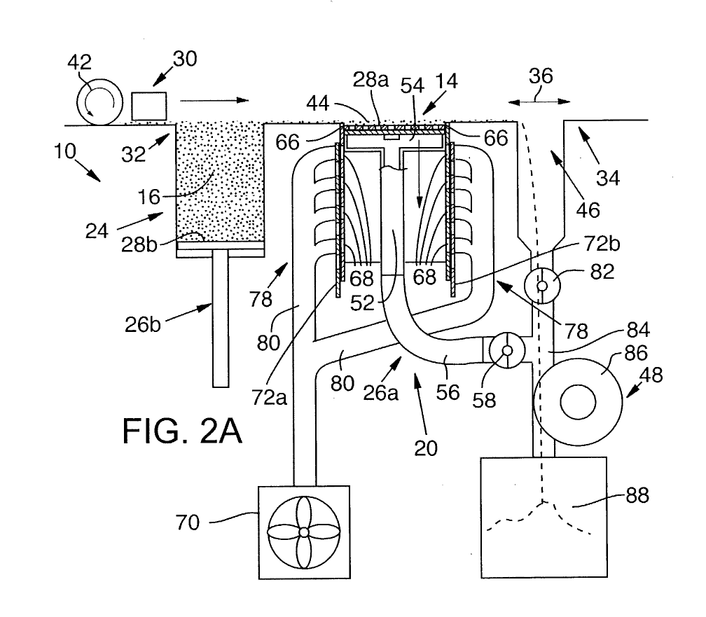

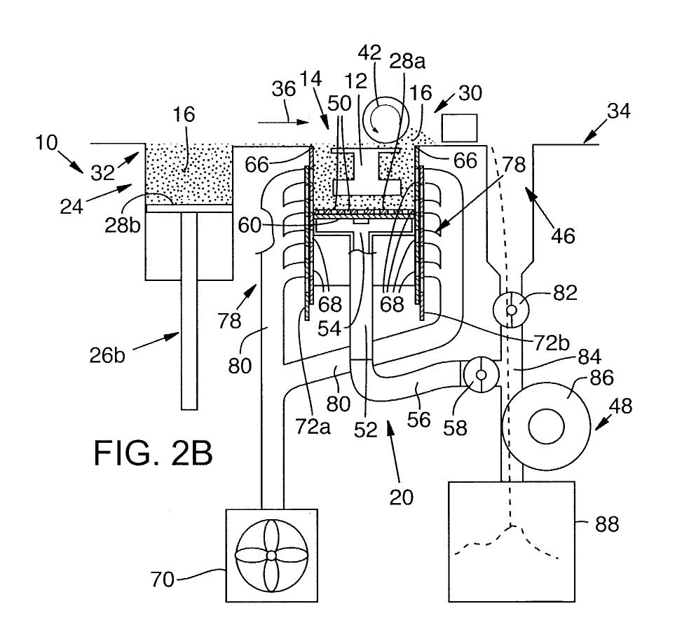

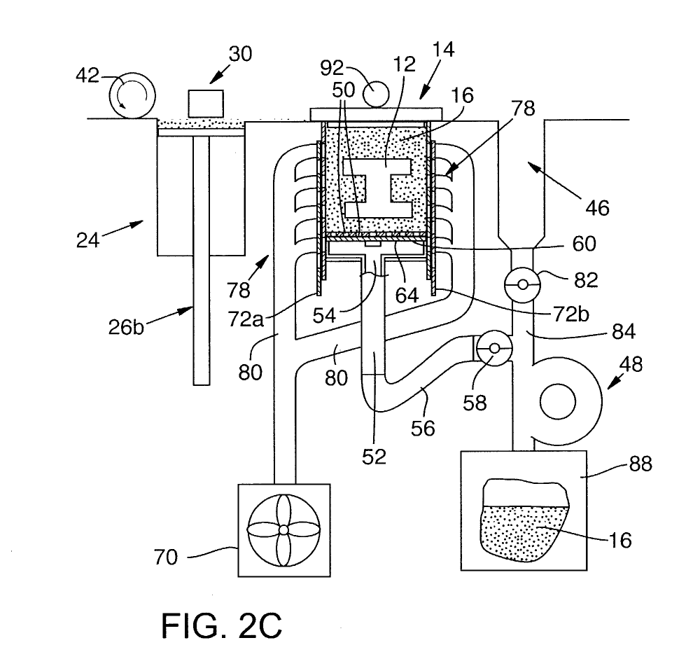

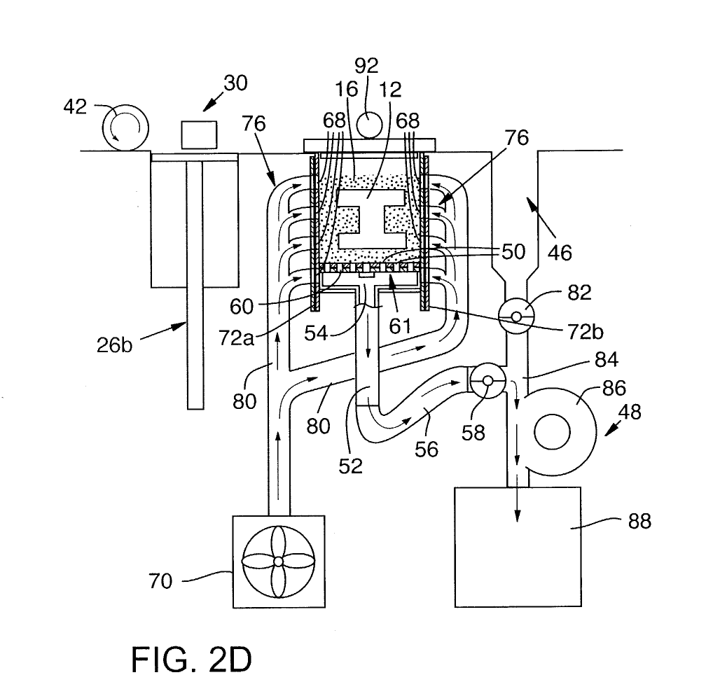

The movable carriage 30 also includes a roller 42 for transferring unbound powder 16 from the source chamber 24 to the building chamber 14. For example and as best shown in FIG. 2A, the axis of roller 42 is aligned in the y-direction 40 and extends over chambers 14, 24 such that movement of the carriage in the x-direction 36 allows the roller 42 to move unbound powder 16 that has been pushed up from the source chamber 24 above the x-y plane 34 by the piston assembly 26b toward the building chamber 14.

The piston assembly 26a in the building chamber 14 moves the floor 28a of the building chamber 14 down by a defined level to allow a layer of unbound powder 44 to be deposited into the building chamber 14 by the roller 42. Any excess unbound powder 16 is pushed by the roller 42 to an overflow vent 46 where it is reclaimed by a vacuum system 48.

The carriage 30 then delivers the printhead to desired locations over the building chamber 14 on the x-y plane 34 and the printhead selectively deposits bonding liquid onto the layer of unbound powder 44 thereby bonding defined regions of powder on the layer of unbound powder 44 in the building chamber 14. The piston assembly 26b in the source chamber 24 then urges more unbound powder 16 above the x-y plane 34 and the piston assembly 26a in the building chamber 14 lowers the 28a of the building chamber 14 by a defined distance to allow another layer of unbound powder to be deposited by the roller 42. The carriage 30 is then positioned over the new layer of unbound powder in the building chamber such that the printhead can selectively deposit bonding liquid thereon to form a region of bound powder that also bonds with the lower portion of bound powder.

The three-dimensional object fabricator 10 is used to form a physical prototype object 12 from computer data of such image produced using a computer aided design or computer aided manufacturing program or the like. In general, when a user desires to fabricate a prototype object 12 of the stored computer data of that object, the user exports the stored computer data to a computer program that sections the digital representation of the object into a plurality of discrete two-dimensional layers, with each layer having a predefined thickness.

The computer program “prints” each layer by instructing the carriage 30, printhead, source chamber piston assembly 26b, and building chamber piston assembly 26a as needed to deposit layers of unbound powder into the building chamber 14 and eject corresponding bonding fluid at key locations on the layers of unbound powder, thereby forming a physical object 12 of bound powder having the dimensions of the computer data model for that object.

B. Exemplar Integral Powder Removal System

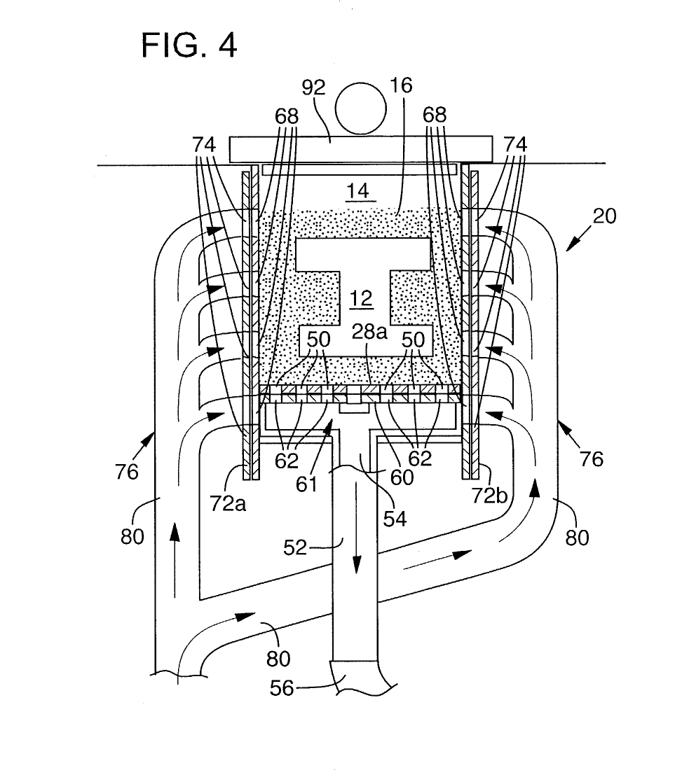

As best shown in FIGS. 1 and 2A, the three-dimensional object fabricator 10 also includes an unbound powder removal system 20 integral to the building chamber 14. For example, the floor 28a of the building chamber includes a plurality of vacuum vents 50 in pneumatic communication with the vacuum system 48. The piston assembly 26a includes a piston 52 defining the floor 28a of the building chamber 14. The piston 52 includes a pneumatic chamber 54 (FIGS. 2A and 4) therein, thereby allowing the vacuum system 48 to be in pneumatic communication with the vacuum vents 50 on the floor 28a of the building chamber 14. A flexible pneumatic tube 56 runs from the piston 52 to the vacuum system 48. A building chamber vent valve 58 may be positioned in the pneumatic connection between the pneumatic chamber 54 and the vacuum system 48.

The vacuum vents 50 include structures that allow them to be opened and closed. For example, a sliding disk 60 having openings 62 therethrough aligned with the vacuum vents 50 on the floor 28a is operably secured inside the pneumatic chamber 54 adjacent to the upper surface of the piston 52. The disk 60 is typically in communication with the computer system that can command the disk 60 to an opened position 61 (FIG. 4) wherein the openings 62 in the disk 60 align with the vacuum vents 50, thereby placing the vacuum vents 50 in pneumatic communication with the vacuum system 48. The openings 62 and related vacuum vents 50 are usually relatively large to facilitate easy removal of unbound powder 16 from the building chamber 14. However, the openings 62 and related vacuum vents 50 are not so large as to damage the object 12 fabricated within the building chamber 14 during removal of the unbound powder 16 from the building chamber 14.

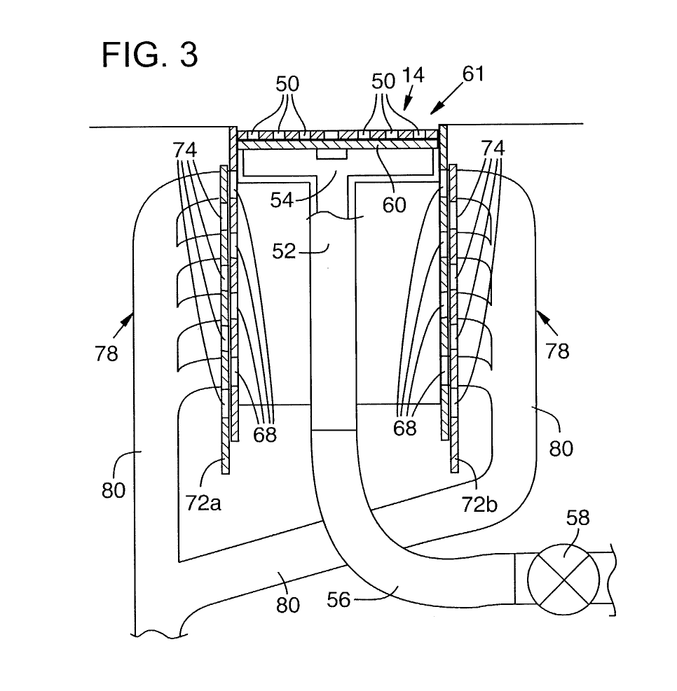

Alternatively, the disk 60 can be commanded to a closed position 64 (FIG. 3) wherein the openings 62 in the disk 60 do not align with the vacuum vents 50, thereby preventing the vacuum vents 50 from being in pneumatic communication with the vacuum system 48. The closed position 64 of the disk 60 also prevents unbound powder 16 from inadvertently entering into the pneumatic chamber 54 in the piston 52, thereby allowing the layers of unbound powder to be established in the building chamber 14 during the building phase of operation of the three-dimensional object fabricator 10.

Typically, the side walls 66 of the building chamber 14 include a plurality of spaced-apart air vents 68 in pneumatic communication with a pressurized air source 70 (FIGS. 1, 2A-D). The air vents are sized to allow pressurized air from the air source 70 to enter the building chamber 14 forcibly to dislodge unbound powder 16 in the building chamber 14, but not so forcibly as to damage the object 12 formed within the building chamber 14.

The air vents 68 include structures that allow them to be opened and closed. For example, sliding disks 72a, 72b having openings 74 therethrough aligned with the air vents 68 on the side walls 66 are operably secured adjacent to the side walls 66 as best shown in FIG. 4. The disks 72a, 72b in some embodiments are in communication with the computer system such that they can be commanded to an open position 76 (FIG. 4) wherein the openings 74 in the disks 72a, 72b align with the corresponding air vents 68, thereby allowing pressurized air from the air source 70 to enter into the building chamber 14. Alternatively, the disks 72a, 72b can be commanded to a closed position 78 (FIG. 3) wherein the openings 74 in the disks 72a, 72b do not align with the corresponding air vents 68, thereby preventing pressurized air from entering into the building chamber 14. The closed position 78 of the disks 72a, 72b also prevents unbound powder 16 from inadvertently entering into the pneumatic tubes 80 leading to the air vents 68, thereby allowing the layers of unbound powder to be established in the building chamber 14 during the building phase of operation of the three-dimensional object fabricator 10.

In some embodiments and as shown in FIG. 1, a vibration generator 96 is operably secured to the building chamber 14 such that when activated, the vibration generator 96 vibrates the building chamber 14 to loosen unbound powder within the chamber.

Also, the vacuum system 48 is typically in pneumatic communication with the overflow vent 46 as shown in FIG. 1. An overflow vent valve 82 is secured to the pneumatic line 84 from the overflow vent 46, thereby allowing the pneumatic flow to be stopped between the overflow vent 46 and the vacuum system 48. More usually, the vacuum system 48 includes a vacuum generator 86 in pneumatic communication with an unbound powder storage chamber 88 wherein unbound powder removed from either the overflow vent 46 or the building chamber 14 by the vacuum system 48 is deposited. If needed, undesirable levels of humidity in the air can be removed with a dehumidifier 90 at the intake of the air source to the vacuum generator 86.

An exemplar use of the three-dimensional object fabricator 10 and integral unbound powder removal system 20 is shown schematically in FIGS. 2A-2D. In FIG. 2A, the three-dimensional object fabricator 0 is in the early stages of fabrication of the object 12. Unbound powder 16 is transferred by the roller 42 from the source chamber 24 to the building chamber 14 and the piston assemblies 26a, 26b in their respective chambers 14, 25 are aligned to distribute a correct amount of unbound powder 16 from the source chamber 24 to create a layer of unbound powder 44 in the building chamber 14. The overflow vent valve 82 is open, thereby placing the overflow vent 46 in pneumatic communication with the vacuum system 48. The building chamber vent valve 58 is closed and the air source 70 is turned off with both the air vents 68 and vacuum vents 50 having their respective disks 72a, 72b, 60 in the closed positions 78, 64.

FIG. 2B shows the three-dimensional object fabricator 10 after several layers of unbound powder 16 have been formed in the building chamber 14 with a section of bound powder defined therein forming the object 12. The building chamber vent valve 58 has remained closed with the air vents 68 and vacuum vents 50 having their respective disks 72a, 72b, 60 in their closed positions 78, 64 through this fabrication phase of the object 12.

FIG. 2C shows the fabricated object 12 fully formed in the building chamber 14, but imbedded in a large quantity of unbound powder 16. A lid 92 is placed over the top of the building chamber 14 thereby preventing any unbound powder 16 from escaping from the top of the building chamber 14. The lid 92 is typically manually placed over the top of the building chamber 14, however an automated lid application assembly (not shown) may also be used. The overflow vent valve 82 is closed. The building chamber vent valve 58 is opened and the vacuum vent disk 60 positioned to its open position 61, thereby allowing unbound powder 16 in the building chamber 14 to be removed from the building chamber 14.

A cut-off switch (not shown) may be provided between the lid 92 and frame 22 such that the lid 92 must be properly seated over the building chamber 14 for the air source 70 to be activated. This prevents inadvertent release of unbound powder 16 through the top of the building chamber 14 with the air source 70 activated but no lid 92 covering the building chamber 14. In some embodiments, the disks 60, 72a, 72b associated with the vacuum vents 50 and air vents 68 are biased to their closed positions 64, 78 (FIG. 2D) and move to their open positions 61, 76 (FIG. 2D) when the lid 92 is detachably secured to the frame 22.

FIG. 2D shows the air source 70 being activated with the air vents' disks 72a, 72b being commanded to their opened positions 76, thereby allowing pressurizing air to enter the building chamber 14 through the air vents 68 while unbound powder 16 continues to exit the building chamber 14 through the vacuum vents 50. This configuration is maintained until all of the unbound powder 16 is removed from the building chamber and only the fabricated object 12 remains in the building chamber 14 for easy removal. Typically, the vibration generator 96 (FIG. 1) is also activated during this phase to loosen any unbound powder that has become stuck within the building chamber 14, thereby allowing it to be removed by the vacuum system 48.

If desired, the unbound powder storage chamber 88 includes an access door 94 (FIG. 1) and a removable receptacle (not shown) therein for collecting the unbound powder 16. Accordingly, the unbound powder 16 can be easily reused by removing the receptacle containing it from the unbound powder storage chamber 88, and pouring the unbound powder 16 from the receptacle into the source chamber 24.

C. Alternative Embodiments

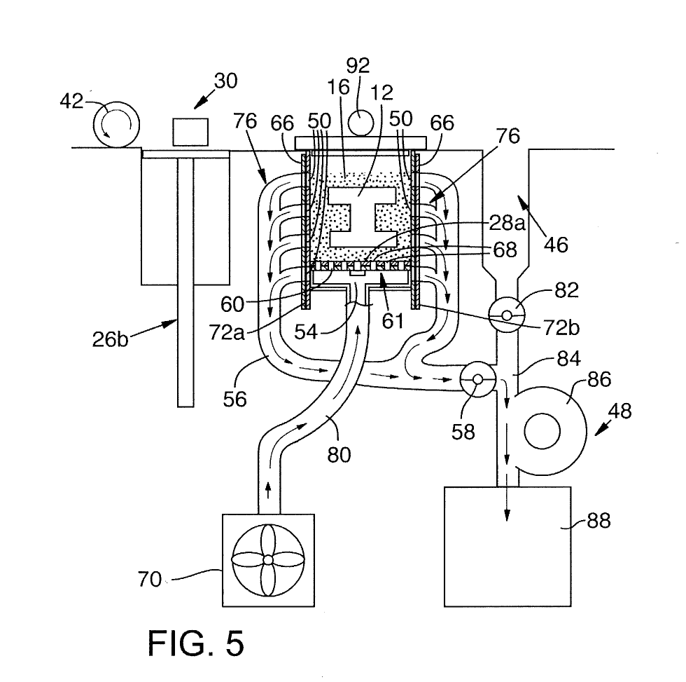

An alternative embodiment of the present invention includes positioning the vacuum vents 50 and air vents 68 about the boundary of the building chamber 14 as needed. For example and as shown in FIG. 5, the vacuum vents 50 can be in the side walls 66 of the building chamber 14 and the air vents 68 can be on the floor 28a of the building chamber 14. In such case, pneumatic tube 80 is flexible and runs from the air source 70 to the air vents 68 on the moveable floor 28a of the building chamber 14, and pneumatic tube 56 operably engages the vacuum system 48 and the vacuum vents 50 positioned on the side walls 66 of the building chamber 14. Similarly, both the side walls 66 and floor 28a of the building chamber 14 can include both air vents 68 and vacuum vents 50.

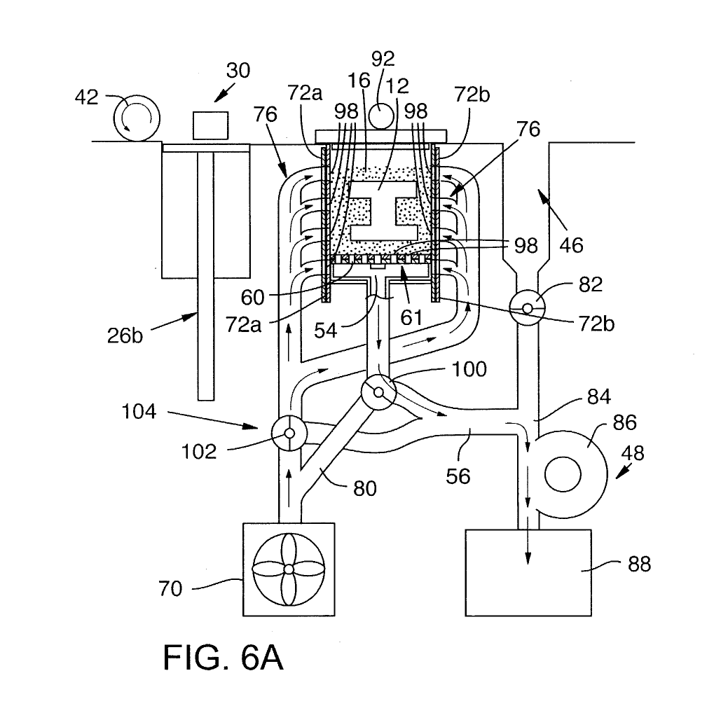

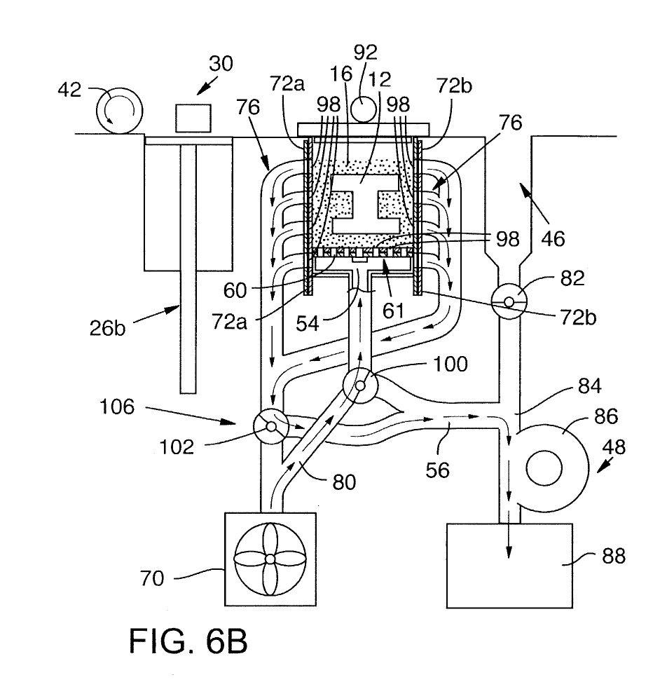

Alternatively, vents 98 (FIGS. 6A and 6B) on the side walls 66 and floor 28a of the building chamber 14 can be used for both delivering pressurized air into the building chamber 14 from the air source 70 and removing unbound powder 16 from the building chamber 14 to the vacuum system 48. An exemplar pneumatic configuration for such a system is shown in FIGS. 6A and 6B. Vents 98 in the floor are in pneumatic communication with both the air source 70 and vacuum system 48 at pneumatic valve 100. Similarly, vents 98 in the side walls 66 are in pneumatic communication with both the air source 70 and vacuum system 48 at pneumatic valve 102.

The pneumatic valves 100, 102 are configured to allow only the air source 70 or the vacuum system 48 to be in pneumatic communication with a set of respective vents 98 at a given time. As shown in FIG. 6A, pneumatic valves 100, 102 have respective first positions 104 wherein the air source 70 is in pneumatic communication with the vents 98 in the side walls 66 through valve 102 and the vacuum system 48 is in pneumatic communication with the vents 98 in the floor 28b, through pneumatic valve 100. Similarly, as shown in FIG. 6B, pneumatic valves 100, 102 have respective second positions 106 wherein the air source 70 is in pneumatic communication with the vents 98 in the floor 28b through valve 100 and the vacuum system 48 is in pneumatic communication with the vents 98 in the side walls 66 through valve 102.

The disks 60, 72a, 72b of some embodiments corresponding with the vents 98 typically include two different sized openings that can be aligned with each vent 98 in their respective opened position. One opening is smaller than the other. The smaller opening is aligned with the vent 98 when the vent 98 is providing pressurized air to the building chamber 14. The reduced size of the opening increases the velocity of the air entering the building chamber, thereby facilitating movement of the unbound powder within the chamber. Similarly, the larger opening is aligned with the vent 98 when the vent 98 is in pneumatic communication with the vacuum system 48, thereby increasing the volume of unbound powder that can be removed from the building chamber 14 through the vent 98.

Usually, the pneumatic valves 100, 102 are in communication with the computer system, which commands the pneumatic valves 100, 102 between their respective first and second positions on a periodic cycle during the unbound powder removal phase. Accordingly, the vents 98 alternate between delivering pressurized air to the fabrication chamber and removing unbound powder from the fabrication chamber.

More typically, a vent regulator modulates the size of the vents. For example, the disks 60, 72a, 72b can be in communication with the computer system, which commands each disk 60, 72a, 82b to align either the large or small openings therethrough with the respective vents 98 based on the commanded position of the valves 100, 102.

If needed, the vibration generator 96 (FIG. 1) may also be also operated during the unbound powder removal phase to further facilitate breakdown and removal of unbound powder from the building chamber 14. The vibration generator 96 in some embodiments is usually in communication with the computer system and activated as needed by the computer system

Having here described several embodiments of the present invention, it is anticipated that other modifications may be made thereto within the scope of the invention by individuals skilled in the art. For example, the three-dimensional object fabricator 10 can be any type of object fabricator that fabricates three dimensional objects in a chamber of unbound powder, including by not limited to so-called “inkjet” object fabricators, laser sintering object fabricators, and the like.

Thus, although several embodiments of the present invention have been described, it will be appreciated that the scope of the invention is not limited to those embodiments, but extend to the various modifications and equivalents as defined in the appended claims.

What is claimed is:

1. An unbound powder removal system for a three-dimensional object fabricator that forms an object in a chamber of unbound powder by binding regions of the unbound powder, said unbound powder removal system including:
a vacuum vent operably secured to a boundary of the chamber; and
a vacuum source in pneumatic communication with the vacuum vent such that unbound powder may be automatically removed from the chamber through the vacuum vent.

2. The unbound powder removal system for a three-dimensional object fabricator of claim 1, wherein said vacuum vent has an opened position wherein said vacuum vent is in pneumatic communication with the vacuum source, and a closed position wherein said vacuum vent is pneumatically isolated from the vacuum source.

3. The unbound powder removal system for a three-dimensional object fabricator of claim 1, wherein said chamber has a floor and said vacuum vent is positioned on said floor.

4. The unbound powder removal system for a three-dimensional object fabricator of claim 1, wherein said chamber has a side wall and said vacuum vent is positioned on said side wall.

5. The unbound powder removal system for a three-dimensional object fabricator of claim 1, further including a vibration generator operably secured to said chamber.

6. The unbound powder removal system for a three-dimensional object fabricator of claim 1, further including a plurality of spaced-apart vacuum vents operably secured to the boundary of the chamber and in pneumatic communication with said vacuum source.

7. The unbound powder removal system for a three-dimensional object fabricator of claim 1, further including an air vent operably secured to the boundary of said chamber and in pneumatic communication with an air source.

8. The unbound powder removal system for a three-dimensional object fabricator of claim 7, wherein said air vent is operably secured to a wall of the chamber and said vacuum vent is operably secured to a floor of the chamber.

9. The unbound powder removal system for a three-dimensional object fabricator of claim 7, wherein said air vent is operably secured to a floor of the chamber and said vacuum vent is operably secured to a wall of the chamber.

10. The unbound powder removal system for a three-dimensional object fabricator of claim 7, further including a lid removably secured to the chamber.

11. The unbound powder removal system for a three-dimensional object fabricator of claim 10, wherein said air source is operational only when said lid is operably secured to said chamber.

12. The unbound powder removal system for a three-dimensional object fabricator of claim 7, further including a plurality of spaced apart air vents operably secured to the boundary of said chamber and in pneumatic communication with said air source.

13. The unbound powder removal system for a three-dimensional object fabricator of claim 7, wherein said air vent has an opened position wherein said air vent is in pneumatic communication with the air source, and a closed position wherein said air vent is pneumatically isolated from the air source

14. The unbound powder removal system for a three-dimensional object fabricator of claim 1, further including an unbound powder storage chamber having an access door to allow removal of unbound powder inside the unbound powder storage chamber.

15. The unbound powder removal system for a three-dimensional object fabricator of claim 1, wherein said three-dimensional object fabricator is an inkjet object fabricator.

16. The unbound powder removal system for a three-dimensional object fabricator of claim 1, wherein said three-dimensional object fabricator is a laser sintering object fabricator.

17. The unbound powder removal system for a three-dimensional object fabricator of claim 1, further including:
a source of pressurized air in pneumatic communication with the vent; and,
a switch for switching between delivering pressurized air to the chamber through the vent from the pressurized air source and removing unbound powder from the chamber to the vacuum system through the vent.

18. The unbound powder removal system for a three-dimensional object fabricator of claim 17, wherein said the size of said vent is larger when operably secured to the vacuum system than when operably secured to the source of pressurized air.

19. The unbound powder removal system for a three-dimensional object fabricator of claim 17, further including:
a second vent in pneumatic communication with said vacuum system and said source of pressurized air; and,
a second switch for switching between delivering pressurized air to the chamber through the second vent from the pressurized air source and removing unbound powder from the chamber to the vacuum system through the second vent.

20. The unbound powder removal system for a three-dimensional object fabricator of claim 19, wherein said first switch is positioned to deliver pressurized air to the chamber when said second switch is positioned to remove unbound powder from the chamber to the vacuum system.

21. The unbound powder removal system for a three-dimensional object fabricator of claim 20, wherein said first switch is positioned to remove unbound powder from the chamber to the vacuum system when said second switch is positioned to deliver pressurized air to the chamber from said pressurized air source.

22. The unbound powder removal system for a three-dimensional object fabricator of claim 17, further including a vent regulator operably secured to the vent for modulating the size of the vent.

23. The unbound powder removal system for a three-dimensional object fabricator of claim 22, wherein said vent regulator is a disk having a plurality of different sized openings therein, said disk operably secured to the vent such that one opening of said plurality of openings aligns with the vent to define a size of the vent.

24. A three-dimensional object fabricator having:
a source chamber for receiving unbound powder therein;
a building chamber having a boundary and an upper edge;
a carriage movable along a horizontal plane over the source and building chambers;
an unbound powder mover operably secured to the carriage to move unbound powder from the source chamber to the building chamber thereby forming a layer of unbound powder in the building chamber;
a bonding fluid ejector in fluid communication with a source of bonding fluid, said bonding fluid ejector operably secured to and movable along a longitudinal length of the carriage such that the bonding fluid ejector is positionable on the horizontal plane adjacent to the building chamber, the bonding fluid bonding a region of the layer of unbound powder in the building chamber to form a region of bound powder.
an unbound powder removal system operably secured to the boundary of the building chamber such that unbound powder may be removed from the chamber after the region of bound powder is formed in the building chamber.

25. The three-dimensional object fabricator of claim 24, wherein said unbound powder removal system includes:
a vacuum vent operably secured to the chamber and in pneumatic communication with a vacuum source; and,
an air vent operably secured to the chamber and in pneumatic communication with an air source.

26. The three-dimensional object fabricator of claim 24, further including:
a plurality of spaced apart vacuum vents operably secured to the chamber and in communication with the vacuum source; and,
a plurality of spaced apart air vents operably secured to the chamber and in communication with the air source.

27. The three-dimensional object fabricator of claim 26, wherein said plurality of spaced apart vacuum vents are operably secured to a floor of the chamber and said plurality of spaced apart air vents are operably secured to at least one side wall of the chamber.

28. The three-dimensional object fabricator of claim 26, wherein said plurality of spaced-apart vacuum vents are operably secured to at least one side wall of the chamber, and said plurality of spaced apart air vents are operably secured to a floor of the chamber.

29. The three-dimensional object fabricator of claim 24, further including a lid detachably secured to the chamber

30. The three-dimensional object fabricator of claim 29, wherein said unbound powder removal system operates only when said lid is detachably secured to said chamber.

31. A method for producing an object using a three-dimensional object fabricator that fabricates objects by bonding regions of unbounded powder in a chamber of unbound powder with an unbound powder removal system operably secured to the chamber, said method comprising the steps of:
operating the three-dimensional object fabricator to produce the object in the chamber of unbound powder;
covering the chamber of unbound powder with a lid;
activating the unbound powder removal system such that unbound powder in the chamber is removed from the chamber while the object remains within the chamber.

32. The method of claim 31, wherein activating the unbound powder removal system includes operating a vacuum source in pneumatic communication with vacuum vents in the chamber.

33. The method of claim 32, wherein activating the unbound powder removal system further includes operating an air source in pneumatic communication with air vents in the chamber.

34. The method with an unbound powder removal system operably secured to the chamber of claim 32, further including the step of operating a vibration generator to loosen regions of unbound powder in the chamber.

35. The method of claim 32, wherein said operating the three-dimensional object fabricator to produce the object in the chamber of unbound powder step includes operating an inkjet printhead to selectively deposit a binder fluid over at least one region of the unbound powder.

36. The method of claim 32, wherein said operating the three-dimensional object fabricator to produce the object in the chamber of unbound powder includes laser sintering the unbound powder.

37. A three-dimensional object fabricator having:
a frame;
a chamber for depositing a layer of unbound powder therein;
means operably secured to the frame for delivering unbound powder to the chamber;
means for selectively binding a region of the layer of unbound powder thereby forming a region of bound powder; and,
means operably secured to the chamber for removing unbound powder from the chamber while the region of bound powder remains within the chamber.

38. The three-dimensional object fabricator of claim 37, further including means for collecting unbound powder removed from the chamber.
